(19) United States
(12) Patent Application Publication
(10) Pub. No.: US 2002/0091646 A1
(43) Pub. Date: Jul. 11, 2002

(54) Method and system for verifying the identity of on-line credit card purchasers through a proxy transaction

(76) Inventors: Lawrence L. Lake, Lake Forest, IL (US); Gregory E. Hedges, River Forest, IL (US); Martin Staks, Park Ridge, IL (US); Edward M. Hau, Chicago, IL (US); Jeffrey T. Eberwein, Bartlett, IL (US); John B. McCormick, Winnetka, IL (US); J. Russell Gates, Naperville, IL (US); Michael J. Feczko, Chicago, IL (US)

Correspondence Address: Larry L. Saret, Michael Best & Friedrich LLC, Suite 1900, 401 North Michigan Avenue, Chicago, IL, 60611, US

(21) Appl. No.: 09/986,218

(22) Filed: Oct. 22, 2001

Related U.S. Application Data
(60) Provisional application No. 60/245,768, filed on Nov. 3, 2000.

(51) Int. Cl. G06F 17/60

(52) U.S. Cl. 705/67

(57) ABSTRACT

The present invention provides a proxy process and system for emulating card-present credit card transactions in credit card transactions occurring over a computer network. The process involves collecting credit card information and identification information from the cardholder and presenting that information to an identifier. Once the cardholder has been identified by the identifier, an authentication server generates a code and transmits the code to the cardholder to “set up” the credit card. The cardholder possessing both the credit card information and the code then sends that information and code from the cardholder's PC to the authentication server, which compares the credit card information and code to the credit card information and code stored from the credit card set up and if they match, a secure pay digital certificate is issued to the cardholder's computer. The certificate identifies the cardholder's computer as belonging to the person authorized to enter into purchase transactions using the specified credit card. Thereafter, credit card transactions originating from the cardholder computer possessing the secure pay digital certificate can be assumed to be transactions entered into by the positively identified cardholder. The cardholder may tender the credit card information as payment to an online merchant. The merchant checks for the presence of a secure pay certificate from the cardholder's PC prior to accepting the credit card information as payment, and verifies the validity of the certificate.

This application claims priority on Provisional Application Serial No. 60/245,768.

### BACKGROUND OF THE INVENTION

The present invention relates to a method of and system for verifying the identity of an on-line purchaser using a credit card or Smart Card as payment for goods or services from a merchant (a “credit card transaction”) conducting business over a computer network such as the Internet. A “Smart Card” is a credit card that contains electronically stored and modifiable information, and that conforms to certain standards set by the credit card industry. As used herein, the term “credit card” includes but is not limited to a Smart Card. Increasing numbers of consumer transactions are taking place over computer networks. Because the parties to such electronic transactions are remote from one another, and usually unknown to one another, a secure trusted mechanism for electronically tendering payment is necessary. Credit card payment has become the defacto industry standard for on-line merchants accepting payment over a computer network.

A significant problem with accepting credit card payment over a computer network, however, is fraud. Generally, all that is required of a consumer making a credit card purchase over a computer network is that the consumer supply the cardholder's name, the credit card number, and the expiration date of the credit card to the merchant. The merchant never has the opportunity to see the consumer, the credit card, the consumer's signature, or any other type of identification such as a photo ID in order to determine that the consumer presenting the credit card information is in fact the person entitled to use the card. As a result, it is relatively easy for criminals to improperly obtain credit card information from others and make unauthorized purchases over a computer network using the stolen credit information.

Card-not-present (CNP) transactions, such as those that take place over a computer network, create an added level of risk for on-line merchants, as compared to Card-present transactions in which the cardholder is present at the merchant's premises, where the merchant swipes the credit card to read the data coded on the magnetic stripe on the back of the card. According to credit card issuer rules, the credit card issuer is liable for charge backs due to fraudulent credit card transactions, provided that the consumer entering the transaction is present at the merchant's premises with the credit card in-hand when the transaction takes place. The card must be swiped through a point of sale (POS) terminal for card validation and authorization of the transaction. When the transaction has been approved, the POS terminal provides an authorization code to the merchant. With card not present (CNP) transactions, however, it is the merchant who is liable for charge backs due to fraud. This potential added liability is a major impediment to doing business over a computer network because the rates of credit card fraud are as much as 50% higher for computer network transactions than for traditional transactions actually carried out at the merchant's premises.

Thus, a need has existed for some time for a method or system for verifying the identity of an on line purchaser, and ensuring to a reasonable extent, that the purchaser is in fact the party authorized to use the credit card presented for payment. Previous attempts have been made to provide a hardware solution whereby a magnetic card reader is connected to a consumer's PC and the consumer swipes the card through the card reader when entering a credit transaction over a computer network. This solution, however, is cumbersome and requires that the consumer purchase and add hardware to his or her personal computer system. Furthermore, it does nothing to prevent the purchaser from using stolen cards so long as the card itself is physically present and may be swiped through the local card reader. It is clear that a reliable easy-to-use method and system for verifying the identity of on-line purchasers and ensuring that they are authorized to use the credit cards they present for payment is needed to protect on-line merchants and facilitate electronic commerce over a computer network.

### SUMMARY OF THE INVENTION

The present invention relates to a proxy process for emulating card-present credit card transactions in credit card transactions occurring remotely over a computer network such as a computer network. The invention further encompasses a system for implementing such a process. The process of the present invention allows an on-line merchant to be reasonably assured that a customer tendering a credit card as payment to the merchant is a person who is authorized to use the credit card being tendered. The proxy process requires the credit cardholder to personally present the credit card to a designated identifier prior to the initial purchase only. The designated identifier may be an agent, either electronic or otherwise, or some other third party entity which may be relied on to make a positive identification of the customer and transmit information regarding the credit card and the customer to an authentication server as described below.

The customer performs an identification transaction with the identifier wherein the identifier positively identifies the cardholder as an individual authorized to use the credit card and an authentication server issues a unique identifier, such as a code. The identifier temporarily binds the identity of an individual possessing both the code and card information, such as the account number, card expiration date, and full name embossed on the face of the credit card, to that of the credit cardholder who presented the credit card to the identifier. A record of the identification transaction including the credit card information, the code, and the identity of the credit cardholder is created and stored on an authentication web server connected to the designated identifier via a computer network.

After the customer has set up his or her credit card by performing the identification transaction before the designated identifier or identification agent, the customer may return to his or her personal computer and contact a specific web server referred to here as an “authentication server” over a computer network. The customer enters his or her credit card information (e.g. account number, card expiration date, name, and other information) along with the unique identifier received from the identification agent and transmits the data to the authentication server. The authentication server compares the credit card information and code submitted from the cardholder's computer to the credit card information and code stored in the record of the identification transaction that occurred with the identifier. If the data match, a secure pay digital certificate is sent from the authentication web server to the cardholder's computer.

Once the customer has received a secure pay digital certificate, the customer may enter a transaction with the merchant and pay by the credit card which was set up as described above. The merchant checks for a valid certificate from the authentication web server on the customer's computer before accepting the credit card information as payment.

A system for implementing a secure pay method as described above forms another aspect of the invention. The system provides for a proxy card-present transaction for a credit card transaction occurring over a computer network. The system allows a merchant to be reasonably sure that a remote customer tendering a credit card as payment is in fact an individual authorized to use the credit card. The major components of the system include an identity verification agent, a customer computer, a merchant web server, and an authentication authority web server. All of these components are interconnected with one another over a computer network.

The identity verification agent may be a human attendant outfitted with a typical credit card point of sale terminal or may be an automated device such as an existing automated teller machine. In either case, the identity verification agent is provided with the ability to positively identify the customer visually, either by PIN number or by some other means when the customer personally presents the credit card to the identity verification agent. Once a positive identification has been made, the identification agent sends a record of the positive identification along with information from the credit card to the authentication authority web server.

Upon receiving the record of the positive identification of the customer, the authentication authority web server is configured to generate a unique code associated with the positive identification. The authentication web server then stores the record of the positive identification along with the code, and transmits the code to the identity verification agent for presentment to the customer. The customer computer in turn, includes input means whereby the customer may input information from the credit card along with the code into the customer computer and transmit the code and credit card information back to the authentication web server. The authentication web server further includes means for comparing the credit card information and code received from the customer computer with that previously stored on the authentication web server as a result of the positive identification made by the identity verification agent. The authentication server also includes means for generating a unique digital certificate and means for transmitting the certificate to a customer computer upon a determination that the code submitted by the customer and the code issued by the authentication server match.

Once the customer computer has been set up with the appropriate secure pay digital certificate, the customer is free to enter into transactions with a merchant. The merchant web server includes means for determining whether a valid digital certificate issued from the authentication authority is present on the customer computer. If a certificate is present and valid, the transactions are allowed to proceed.

### BRIEF DESCRIPTION OF THE DRAWINGS

FIG. 1 is a flow chart showing an overview of the secure pay method according to the present invention;

FIG. 2 is a schematic representation of a system for implementing the method of FIG. 1;

FIG. 3 is a detailed flow chart of the credit card setup procedure of FIG. 1;

FIG. 4 is a detailed flow chart of the PC setup procedure of FIG. 1;

FIG. 5 is a detailed flow chart of the merchant setup procedure of FIG. 1; and

FIG. 6 is a detailed flow chart of a secure pay transaction according to the present invention.

### DETAILED DESCRIPTION OF THE INVENTION

### Overview

The present invention relates to a secure payment method for verifying the identity of purchasers taking part in credit card transactions occurring remotely over one or more computer networks such as a computer network. The invention further provides a system for implementing the inventive method. The components of such a system include, but are not limited to, one or more designated trusted identity verification agents, such as ATMs, and the associated ATM network; an authentication server; a credit cardholder's personal computer (PC); a merchant web server; and a card issuer web server. All of these components are interconnected via a common computer network or combination of networks such as a computer network. To secure privacy and to assure the integrity of the data being transmitted between components, secure socket layers (SSL) are established between the components over the network, as is known in the art.

The method according to the present invention involves the steps of positively identifying a credit cardholder as the individual authorized to enter transactions using the credit card by way of a proxy card-present transaction, wherein the cardholder must present the credit card to a designated identifier such as a trusted identity verification agent. The proxy transaction includes many of the steps that normally take place when a customer presents a credit card to a traditional merchant, including swiping the card through a magnetic card reader to obtain the data stored on the magnetic stripe on the back of the card. Once the cardholder has been positively identified, the authentication server generates a unique identifier or authentication code uniquely associated with the proxy transaction and transmits the code to the identity verification agent, which then presents the authentication code to the cardholder. A record of the proxy transaction, including the unique identifier or authentication code associated therewith, is stored in a database associated with a central authentication server. A person later having possession of both the card information of the card presented to the identity verification agent and the code issued by the authentication server is presumed to be the same person who presented the card to the identity verification agent. Collectively, the steps required for performing the positive identification and generating the authentication code associated with the proxy transaction are referred to as “setting up” the credit card.

Once the credit card has been set up, the cardholder must set up his or her personal computer. This involves contacting the authentication server over the computer network from the cardholder's PC and submitting the card information of the same credit card that was presented to the identity verification agent and the unique authentication code generated by the authentication server during the card setup procedure. Upon receiving the credit card information and the proper authentication code, the authentication server compares the card information and the authentication code to the data stored in the data record associated with the proxy transaction. If the data match, it is assumed that the individual operating the computer responsible for contacting the authentication server and forwarding the credit card information and authentication code to the authentication server is in fact the same individual who presented the credit card to the identity verification agent during the credit card setup procedure. Thus, the computer from which the card data and authentication code was received may be considered the authorized cardholder's PC. Once the cardholder's PC has been associated with the cardholder who was positively identified during the card setup procedure, the final step in setting up the cardholder's PC is to issue a secure pay digital certificate from the authentication server to the cardholder's PC. The secure pay digital certificate identifies the cardholder's PC as belonging to the person authorized to enter transactions with the credit card that was set up during the card setup procedure. From this point forward, credit card transactions originating from the cardholder's PC using the card information of the credit card that was set up during the card setup procedure accompanied by the secure pay digital certificate can be assumed to be transactions entered into by the actual cardholder who was positively identified during the card setup procedure. The PC setup procedure may be provided with an option whereby a cardholder may set up multiple computers using this PC setup procedure. Each computer then will include a unique setup code corresponding to the particular machine on which it resides. The codes are specifically tailored to individual machines to prevent the unauthorized copying of the machine set up to another machine.

The card setup procedure and the resulting secure pay digital certificates may be implemented in a number of different ways. The preferred alternatives are set forth in more detail below. However, in keeping with the present overview of the credit card secure pay method and implementing system, the merchant setup and credit card transaction flow will now be briefly described. As noted in the Background section, an important reason for establishing a method and system for verifying the identity of credit cardholders making purchases over computer networks is to protect on-line merchants from fraud. In order for a merchant to take advantage of the present invention, the merchant's web server must be properly set up to evaluate the authenticity of the credit card data transmitted from the cardholder and verify that the person initiating the transaction is in fact the person authorized to use the card.

A number of setup options is available to the merchant depending on the equipment available, and depending on the level of service the merchant wants to receive from the party providing the authentication server services. At a minimum the merchant web server is configured to contact the authentication server to verify the identity of on-line purchasers. The three main service level options are: 1) the authentication server only verifies the identity of cardholders and provides no other services; 2) the authentication server verifies the identity of Smart Cardholders if the merchant is employing the Secure Electronic Transaction (SET) standard; and 3) the authentication server acts as the transaction authorizing agent and obtains transaction approval from the card issuers, in addition to verifying the identity of cardholders. All of these setup options will be described more fully below. When a customer indicates a desire to make a purchase, the merchant web server attempts to establish a public key infrastructure (PKI) session with the cardholder's PC. The merchant's web server explores the cardholder's PC looking for the presence of a secure pay digital certificate. If a certificate is present, the merchant contacts the authentication server to verify that the customer's secure pay certificate is still valid. If the customer's certificate has not been revoked, the authentication server returns a positive authentication to the merchant along with biometric and any other authenticating information. The merchant must then receive authorization for the transaction from the credit card issuer. This may proceed along traditional credit card authorization channels, or the authentication server may also function as a transaction authorization agent as will be described more fully below. Once the merchant receives an authorization code from the card issuer, the parties may close the sale.

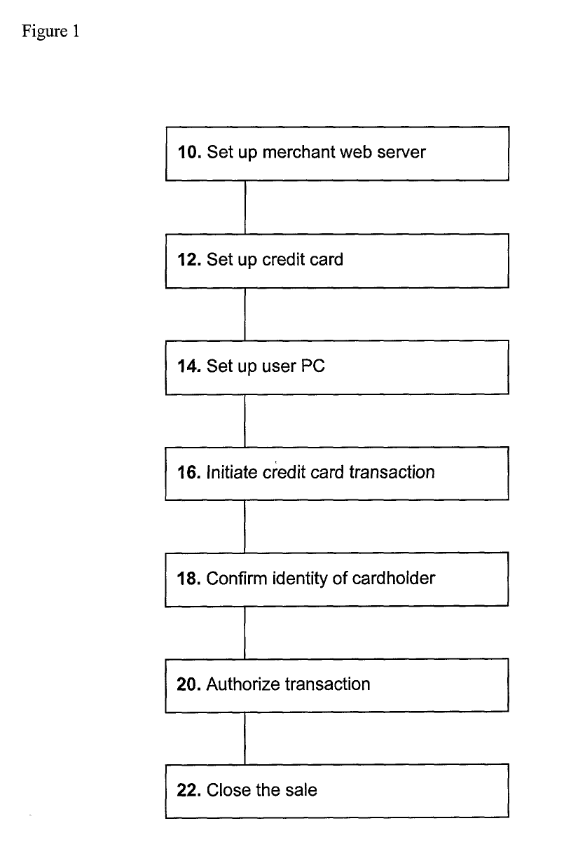

The flow chart of FIG. 1 provides an overview of the secure pay method in which the identity of an on-line purchaser paying by credit card is verified. At step 10 the merchant's network web server is set up to process secure pay transactions. At step 12 the cardholder sets up the credit card in a proxy transaction that takes place before a trusted identity verification agent. At step 14 the cardholder sets up the cardholder PC using a code obtained from an authentication server in step 12. The PC setup results in a digital certificate being sent to the cardholder for use in future on-line credit card transactions. A record of the cardholder's credit card information and a private key for decoding the cardholder's digital certificate are stored on the authentication server. At step 16 the cardholder initiates a credit card transaction with a merchant who is set up to process secure pay credit card transactions. The cardholder's identity is confirmed at step 18, and the transaction is authorized by the card issuer at step 20. Once the merchant receives an authorization code from the card issuer at step 20, the parties may conclude the transaction at step 22.

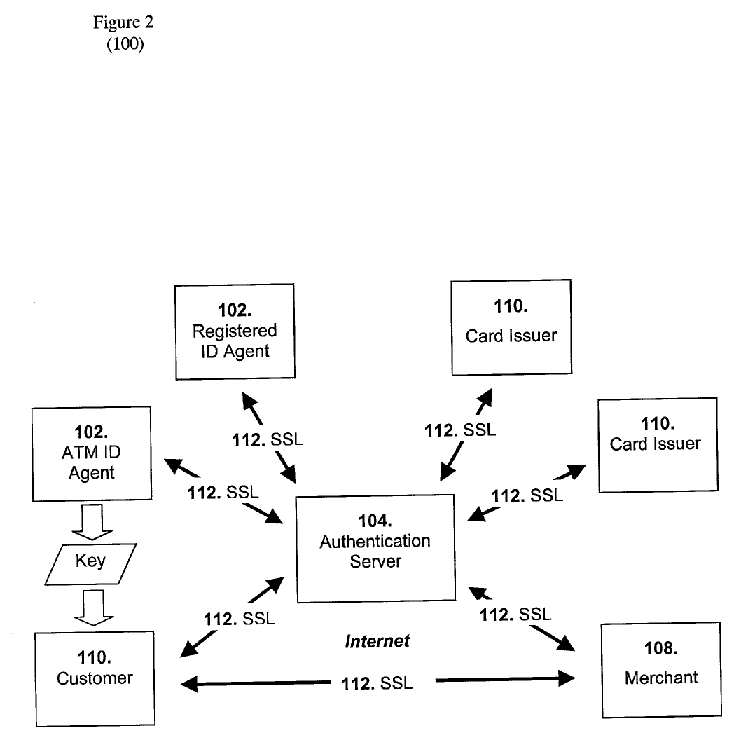

A system for carrying out the method of the present invention, as well as a more detailed description of the various method steps, will now be provided in combination with FIGS. 2-6. A system 100 for carrying out the inventive method is shown schematically in FIG. 2. System 100 comprises an identity verification agent 102, an Authentication Server 104, a credit cardholder's Personal Computer (PC) 106, a Merchant's Internet web server 108, and a credit card issuer's web server 110. The various components interact with one another as described below over a multitude of network connections 112 which are generally known as Internet Secure Socket Layers (SSL).

### Credit Card Setup

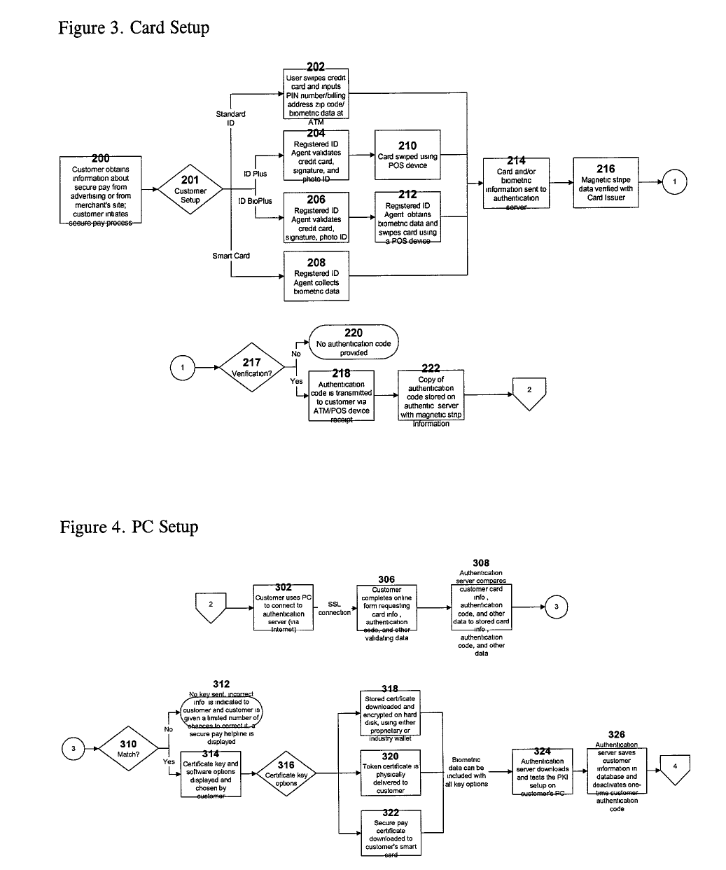

The credit card setup procedure may be implemented in a number of different ways depending on the technology to be employed, and the level of certainty that is desired in identifying the credit cardholders. The process begins at function block 200 of the flow chart of FIG. 3, when the cardholder receives instructions for using the secure pay method from merchant advertising. Following the instructions, the cardholder presents his or her credit card to a designated identifier, such as trusted identity verification agent 102, for a proxy transaction.

The data collected by the identity verification agent 102 includes both credit card information and identification information. This data will vary depending on the customer setup option implemented in decision block 201. In general, the credit card information may include personal information, and other information such as card validation identifier (“CVV2”), magnetic stripe information and credit card number and expiration date. The credit card information may be printed or electronically or magnetically stored on the card. The identification information may include the personal identification number (“PIN”) and personal biometric information. Biometric information includes physical information unique to an individual which is captured electronically or photographically, including but not limited to a finger print, retinal scan, voice print or photograph. The identity verification agent 102 need not necessarily be a human being. For example, the identity verification agent 102 may be an Automated Teller Machine (ATM) capable of reading the magnetic stripe on the back of the credit cards and receiving a Personal Identification Number (PIN) entered by the cardholder. The ATM may then perform a check using the existing ATM network to ensure that the PIN entered by the cardholder is correct, as is known in the art. This procedural option is shown in function block 202. Upon matching the PIN with the credit card data, the true identity of the credit cardholder may be reasonably assured based on the cardholder having possession of the credit card and having knowledge of the correct PIN associated with the card. The ATM in effect performs a proxy transaction standing in for the merchant as in traditional card-present transactions. During the proxy transaction the magnetic stripe of the card is actually read and the identity of the card hard holder is positively established with a reasonable amount of certainty. This proxy transaction may be relied upon for later on-line transactions where the credit card and cardholder are not present, provided that the identity of the person initiating the on-line transaction can be reasonably tracked to the person who performs the proxy transaction.

An alternative to having an ATM function as the identification agent is to establish a person as the agent, the human agent being set up with ATM-like identification capabilities which allow the agent to positively identify the cardholder and record the proxy transaction. This arrangement provides additional levels of security. A live attendant can ask to see a photo ID, compare signatures, as well as observe the cardholder's demeanor. In addition to these added verification checks, the attendant can also swipe the credit card through a standard Point-Of-Sale (POS) terminal, just as is done in traditional card-present transactions carried out at a merchant's premises. This option is shown in function block 204 of the flow chart shown in FIG. 3. The attendant may also require that the purchaser enter a PIN into the POS terminal in order to complete the transaction to provide yet another layer of certainty, as is shown in function block 210.

Another option is shown in function block 206. Here a live attendant, in addition to checking photo IDs and checking signatures and the like, also obtains and records biometric data such as a thumb print or retinal scan from the credit cardholder, as shown in function blocks 206 and 212. In yet another alternative, shown in function block 208, the credit cardholder may present a Smart card configured according to the credit card industry's secured electronic transaction standard (SET). In this case, the identity verification agent may add digitized biometric data to the authentication server to act as a proxy for the cardholder's Smart card.

Regardless of how the identity verification agent 102 is set up, whether it be an ATM as in function block 202, a registered ID agent checking photo IDs and signatures as in function block 204, an agent checking photo IDs signatures and biometric data as in function block 206, or a registered ID agent entering biometric data onto a Smart card as in function block 208, the role of the identification agent is to establish that the cardholder is in fact who he or she purports to be by performing a proxy card-present transaction. Once the identity verification agent 102 positively identifies the cardholder, it contacts the authentication server 104 in function block 214 via computer network and transfers the card data, along with any biometric data obtained from the cardholder, to the authentication server 104. The authentication server 104 then contacts the card issuer's web server 110 via computer network to verify the magnetic stripe data taken from the card, as shown in decision block 217. If the validity of the card is verified, the authentication server generates a unique identifier such as an authentication code which identifies the proxy transaction and is bound to the credit card data and other identification data associated with the proxy transaction. The authentication server 104 then transmits the authentication code to the identification verification agent 102 for presentation to the cardholder via an ATM or POS terminal receipt, as shown in function block 218. The authentication server stores the authentication code in a database record along with the credit card data and other identification data as shown in function block 222. If the card cannot be verified, no authentication code is issued, as shown in function block 220.

### Cardholder PC Setup

Next, the procedure for setting up the cardholder's PC 110 will be described in detail with reference to FIGS. 2 and 4. The cardholder's PC 106 can only be set up after the cardholder has been issued a credit card and has received the requisite authentication code from the authentication server 104.

The cardholder begins the PC setup process by contacting the authentication server over the computer network at function block 302. An SSL connection is established between the cardholder PC 106 and the authentication server 104. The cardholder completes an on-line form in which the customer's credit card information, the authentication code issued by the authentication server 104, and other verification data such as the cardholder's billing address, mother's maiden name or the like, is transmitted back to the authentication server in block 306. In function block 308 the authentication server compares the credit card information and the authentication code entered by the cardholder to that stored in the authentication server data base. At decision block 310 the authentication server 104 makes a determination whether the credit card information and the code entered by the cardholder matches that stored in the database. If not, no certificate is sent to the cardholder; instead, the cardholder may be provided with instructions explaining how to have the card setup, or to call a 1-800 telephone help line for help in setting up the card, or some other information on how to take advantage of the secure pay system as indicated in function block 312. If the authentication code entered by the cardholder does match the code stored in the authentication server, a secure pay digital certificate and software options are displayed at function block 314. The digital certificate uniquely identifies the cardholder as the individual authorized to enter on-line transactions using the credit card that was set up according to the card set-up procedure described above. The cardholder is presented with options at decision block 316 in which the cardholder may select the format in which the secure pay digital certificate is provided. According to the option shown in block 318, the cardholder may choose to receive a secure pay digital certificate in the form of a PKI encrypted certificate downloaded directly to the cardholder's PC hard drive and stored within the cardholder's web browser and/or an electronic wallet. An electronic wallet may be a proprietary or industry standard software program resident on the cardholder's PC hard drive.

Another option, shown in function block 320, is to receive a hardware token that may be connected to a port, such as a USB port, of virtually any computer. The token includes the digital certificate that identifies the user as the cardholder who was positively identified in the card setup procedure and optionally may include other authenticating data that was obtained during the card setup procedure. The token has the advantage of being portable so that the cardholder may make on-line purchases from different computers. Yet another certificate option is to set up a Smart card with a secure pay SET certificate, or to configure a Smart card to work with the secure pay method of the present invention. This option, shown in function block 322, requires the cardholder to have a properly configured SET Smart card reader.

Regardless of the format of the digital certificate, digitized biometric data (such as mother's maiden name or other identifying information) may be included with the certificate, depending on the hardware available to the cardholder. Biometrics provide additional verifiable data regarding the identity of the cardholder which can be authenticated during the course of over-network credit card transactions if the proper hardware is available. At function block 324 the authentication server validates the cardholder's digital certificate and tests the PKI set up to ensure that future credit card transactions can proceed properly. Once it has been established that the cardholder's PC is operational for performing secure pay credit card transactions, the authentication server deactivates the single-use authentication code that was issued during the credit card setup procedure.

### Merchant Setup

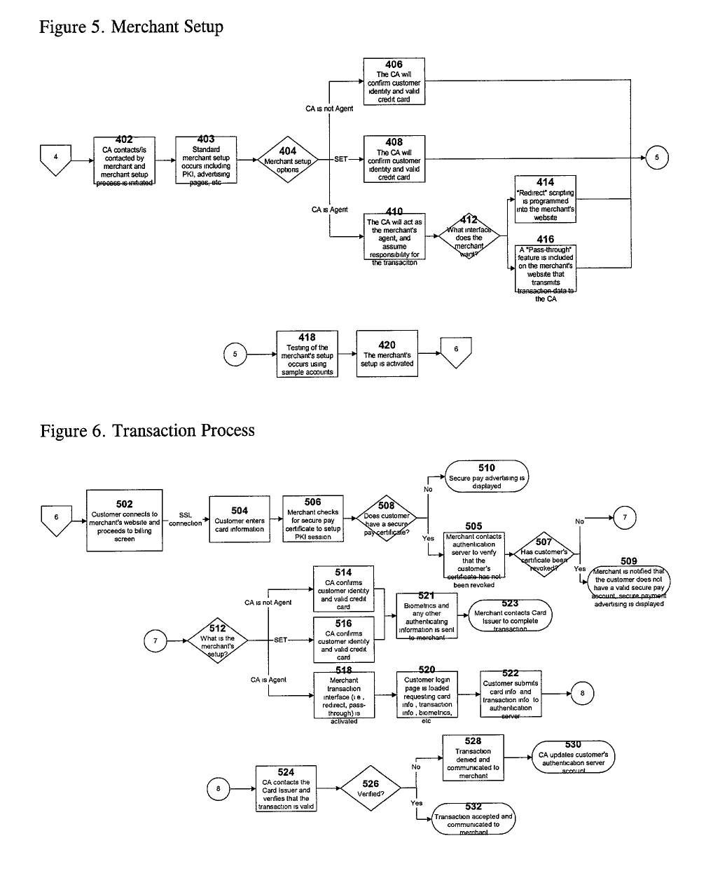

Turning to FIGS. 2 and 5, the merchant setup procedure will now be described. The merchant initiates the setup process at function block 402 of the flow chart of FIG. 5. By contacting the authentication server 104 via the computer network, an SSL connection is established between the authentication server 104 and the merchant's network server 108. At function block 403 merchant setup software is sent from the authentication server to the merchant's web server 108. This download includes software necessary to implement PKI and also includes Internet banners and other software for advertising the presence of the secure pay system and encouraging customers to have their credit cards set up according to the method of the present invention. As indicated by decision block 404, the merchant may select from a number of setup options. The merchant can be set up such that the authentication server 104 functions only as a proxy for card-present transactions and PIN verification. With this option the authentication server merely acts to authenticate the identity of cardholders making purchases on the merchant's web site as shown in function block 406. Or, the merchant can be set up according to the SET standard, with the authentication server acting as a proxy to confirm the cardholder's identity, as shown in function block 408. Finally, the merchant may choose to have the authentication server also act as a transaction authorization agent, wherein the authentication server contacts the credit card issuer's web server 110 to verify the validity of the credit card being offered as payment and to authorize the transaction. In this case, the authentication server forwards information regarding the transaction, such as the purchase amount and other data typically relied on by credit card authorization agents in approving credit card transactions, as well as the credit card magnetic stripe data. If the credit card issuer approves the transaction, a code is sent to the authentication server 104 and is forwarded to the merchant. Under this option, shown in function block 410, the authentication server assumes all responsibility and liability for the transaction. With this setup the merchant may select between two interface options with authentication server 104, as represented by decision block 412. The first interface option, shown in function block 414, redirects the SSL connection between the cardholder's PC 106 and the merchant web server 108 to the authentication server 104. The cardholder's credit card information and the transaction data are all sent to the authentication server and the transaction is processed from there. Alternatively, according to the pass through configuration depicted in function block 416, all data is routed from the merchant web server 108 to the authentication server 104, then back to the merchant web server after the necessary approval codes have been obtained. In either case, the merchant setup is tested at function block 418 using sample accounts and dummy transactions. If the merchant setup passes the tests of step 418, the merchant setup is activated at function block 420 and the merchant may begin processing secure pay credit card transactions over the computer network.

### Transaction Processing

Once the credit cardholder's PC 106 has been set up and a secure pay digital certificate has been issued indicating that the cardholder is in fact who he or she purports to be, the cardholder may enter into credit card transactions with merchants who are set up with the secure pay system. This process is set forth in the flow chart of FIG. 6. The transaction is initiated when the cardholder visits the merchant's network web site and decides to make a purchase. When the purchaser indicates that he or she is ready to make a purchase, typically by mouse clicking on an appropriate icon or soft button embedded within one of the merchant's web pages, the merchant's billing screen is presented to the cardholder as shown at function block 502. The cardholder enters his card data at function block 504, and the merchant's site attempts to initiate a PKI session by checking the customer's browser for the requisite secure pay certificate at function block 506. If the customer has a secure pay certificate, as determined at decision block 508, the merchant's site retrieves the certificate information and sends it to the authentication server 104 to verify that the customer's certificate is still valid as shown in function block 505. If the customer is not on the authentication server's Certificate Revocation List (CRL), as determined at decision function block 507, the customer has a valid secure pay account and the authentication server informs the merchant that the customer is using a valid, properly set up secure pay credit card. If the customer does not have a secure pay certificate, a message is sent to the cardholder's PC 106 explaining how the customer can set up a secure pay account. If the customer has a revoked secure pay certificate, the merchant is informed that the certificate and credit card in question are no longer valid according to the secure pay system at function block 509, and the authentication server takes steps to revoke all of the certificates in existence associated with the card in question.

Next, the merchant's arrangement with the authentication server is determined at decision block 512. If the authentication server is not acting as the merchant's authorization agent, the authentication server confirms the cardholder's identity at function block 514. Similarly, if the merchant is set up according to the SET standard, the cardholder's identity is confirmed at function block 516. In both of the above cases, biometric data and other verification data recorded during the card setup procedure may be sent to the merchant at function block 521. If the authentication server is acting as the merchant's authorization agent, the merchant's transaction interface (i.e. pass through or redirect) with the authentication server is activated at function block 518. The cardholder submits the card data and transaction data to the authentication server at function block 522, and at function block 524 the authentication server contacts the card issuer's network server to determine whether the purchase price is within the cardholder's credit limit and so forth and whether the transaction can go forward at decision block 526. If the transaction is verified according to the card issuer's pre-established conditions, the approval is communicated to the authentication server, which in turn communicates the approval to the merchant web server at function block 532. If the transaction is denied, the merchant is notified at function block 528, and the authentication server updates the cardholder's record in the authentication server database at function block 530. The merchant may then proceed with the transaction with full confidence that the card being offered for payment is valid and that this is not a fraudulent transaction. Another additional security feature that is available is that biometric data may be used to further establish the identity of the purchaser offering the credit card for payment.

### Controls

The aforementioned method and system for verifying the identity of on-line credit card purchasers through a proxy transaction utilizes a number of controls in order to mitigate the risks inherent in such a task. The authentication server maintains transaction logs for all authentication server activity (e.g., cardholder validations and denials) using FDIC Financial Record standards. Certificate usage checks are performed continuously in order to proactively monitor and detect any unusual or fraudulent activity. For example, certificate velocity monitoring is used to determine whether multiple PC's are using the same certificate and, if so, whether the purchase trends indicate fraudulent activity. In addition to these controls, the authentication server utilizes measures to ensure that the cardholder information in its database is kept current. The authentication server communicates with the card issuers to obtain the latest “bad card” lists and immediately removes any accounts relating to cards that are cancelled, lost, stolen, or fraudulent.

Various changes and modifications to the present invention may be made by those of ordinary skill in the art without departing from the spirit and scope of the present invention which is set out in more particular detail in the appended claims. Furthermore, those of ordinary skill in the art will appreciate that the foregoing description is by way of example only, and is not intended to be limiting of the invention as described in such appended claims.

What is claimed is:

1. A proxy process for emulating card-present credit card transactions in credit card purchase transactions occurring remotely between a credit cardholder's computer and a merchant server over a computer network, the process comprising:
(a) collecting credit card information and identification information at a designated identifier;
(b) transmitting the collected credit card information to an authentication server connected to a computer network;
(c) performing an identification transaction wherein the authentication server determines whether the cardholder is authorized to use the credit card and, if so, the authentication server issues a code temporarily binding the identity of an individual possessing the code, the credit card information and the identification information to that of the credit cardholder who presented the credit card to the identifier;
(d) creating a record of the identification transaction including the credit card information, the code, and the identity of the credit cardholder on the authentication server sending the code to the identifier and cardholder;
(e) entering the credit card information and the code into the cardholder's computer and sending the credit card information and code from the cardholder's computer to the authentication server over a computer network;
(f) comparing on the authentication server the credit card information and code submitted from the cardholder's computer to the credit card information and code stored in the record of the identification transaction;
(g) completing the identification transaction by transmitting a digital certificate from the authentication server to the cardholder's computer when the card information and the code submitted from the cardholder's computer match the card information and code stored in the record of the identification transaction on the authentication server;
(h) the cardholder entering a purchase transaction with a merchant over a computer network from the cardholder's computer to the merchant server by offering the credit card information and digital certificate as payment; and
(i) the merchant web server validating the digital certificate from the authentication web server before authorizing the credit card purchase transaction.

2. The proxy process of claim 1 wherein the designated identifier comprises an automated teller machine and the step of performing an identification transaction comprises:
(a) the credit cardholder presenting the credit card to the automated teller machine such that the automated teller machine reads magnetically coded data stored on a magnetic stripe formed on the credit card; and
(b) the automated teller machine verifying that the personal identification number entered by the credit cardholder matches a personal identification number previously assigned to the credit card.

3. The proxy process of claim 1 wherein the designated identifier is a human agent having access to a credit card point-of-sale terminal and wherein the step of performing an identification transaction comprises:
(a) swiping the credit card through the point-of-sale terminal to read data magnetically encoded on a magnetic stripe on the credit card;
(b) generating a paper receipt to record the transaction;
(c) the credit cardholder signing the receipt; and
(d) the agent comparing the signature on the receipt to a signature signed on the credit card.

4. The proxy process of claim 3 wherein the step of performing an identification transaction further comprises determining whether the personal identification number entered by the cardholder matches a personal identification number previously assigned to the card.

5. The proxy process of claim 1 wherein the designated identifier is a human agent having access to a credit card point-of-sale terminal and wherein the step of performing an identification transaction comprises;
(a) swiping the credit card through the point-of-sale terminal to read data magnetically encoded on a magnetic stripe on the credit card; and
(b) the agent viewing a picture identification of the cardholder.

6. The proxy process of claim 1 wherein the step of performing an identification transaction further comprises transmitting to the authentication server the biometric data collected as part of the identification information, and storing the biometric data with the record of the proxy transaction.

7. The proxy process of claim 6 wherein the authentication server contacts a web server of the credit cardholder's card issuer and compares the data received from the cardholder with cardholder data previously received by the card issuer's web server.

8. The proxy process of claim 7 further comprising the steps of:
(a) the cardholder transmitting biometric data associated with the cardholder to the merchant; and
(b) verifying whether the biometric data transmitted by the cardholder to the merchant matches the biometric data obtained during the identification transaction.

9. The proxy process of claim 8 wherein the step of obtaining biometric data comprises obtaining a digital finger print of the cardholder.

10. The proxy process of claim 8 wherein the step of obtaining biometric data comprises obtaining a retinal scan of the cardholder.

11. A secure payment method whereby a merchant accepting a credit card as payment from a customer over a computer network may be reasonably assured that the customer tendering the credit card is a person authorized to use the card, the method comprising the steps of:
(a) performing a proxy card-present transaction where the customer's identity is positively established by submitting the customer's credit card information and biometric information to an identification agent;
(b) providing a unique code to the customer whereby it may be presumed that a person possessing information from the face of the credit card and the unique code is the person who presented the credit card during the proxy transaction;
(c) storing a record of the proxy transaction on a database stored in an authentication server;
(d) contacting the authentication server from the customer's computer over the network and submitting the unique code and the customer's credit card information to the authentication server for comparison with the record of the proxy transaction stored in an authentication server database;
(e) comparing the credit card information and the unique code and, if they match, issuing a secure pay digital certificate to the customer and storing the secure pay digital certificate on the customer's computer;
(f) the customer entering transaction data with the merchant over the network and tendering the credit card as payment; and
(g) the merchant checking for the presence of the secure pay digital certificate on the customer's computer and, upon finding the secure pay certificate, verifying that the certificate and the credit card information tendered by the customer are valid.

12. The secure payment method of claim 11 wherein the step of performing a proxy card-present transaction comprises the customer presenting the credit card to an identification agent, the identification agent reading electromagnetically coded data from the card and positively identifying the customer.

13. The secure payment method of claim 12 wherein the step of performing a proxy card-present transaction further comprises the identification agent recording biometric data from the customer.

14. The secure payment method of claim 13 further comprising the step of the customer submitting biometric data to the merchant along with the credit card information when the credit card is tendered as payment, and wherein the step of verifying that the certificate and the credit card information are valid includes the step of comparing the biometric data submitted by the customer to the biometric data collected by the identification agent.

15. The secure payment method of claim 14 wherein the step of recording biometric data comprises recording a digital finger print.

16. The secure payment method of claim 14 wherein the step of recording biometric data comprises recording a retinal scan.

17. The secure payment method of claim 14 wherein the identification agent comprises an automated teller machine.

18. The secure payment method of claim 14 wherein the identification agent comprises a human attendant having a credit card point-of-sale terminal.

19. The secure payment method of claim 11 wherein the step of issuing a computer readable certificate comprises encoding a PKI digital certificate onto a portable token removably connectable to a computer port.

20. The secure payment method of claim 11 wherein the step of issuing a computer readable certificate comprises transmitting a PKI encoded digital certificate to the customer's computer over a computer network.

21. The secure payment method of claim 11 wherein the database operates in conjunction with an authentication web server and the step of the merchant verifying the validity of the certificate on the customer's computer comprises redirecting the transaction to the authentication web server over a computer network, and the authentication server determining whether the certificate and the credit card information submitted by the customer are valid.

22. The secure payment method of claim 11 wherein the step of the merchant checking for the presence of the secure pay digital certificate on the customer's computer comprises: the merchant initiating a PKI session by checking the customer's browser and, if the secure pay certificate is located therein, the merchant retrieving the certificate information and sending it to the authentication server to verify that the certificate is still valid.

23. The secure payment method of claim 11 and the step of monitoring credit card usage transactions for fraudulent activity.

24. The secure payment method of claim 11 wherein after the merchant verifies the validity of the secure pay digital certificate and credit card information tendered by the customer, transmitting the customer's credit card information from the authentication server to the merchant.

25. The secure pay method of claim 11 wherein after the merchant verifies the validity of the secure pay digital certificate and credit card information tendered by the customer, transmitting the customer's biometric information from the authentication server to the merchant.

26. The secure payment method of claim 11 wherein step (d) includes creating a record of biometric information in the authentication server database.

27. A system for providing a proxy card-present transaction for a credit card transaction occurring over a computer network, whereby a merchant receiving payment via the credit card over a computer network may be reasonably assured that a customer tendering the credit card is an individual authorized to use the credit card, the system comprising:
(a) an identity verification agent, a customer computer, a merchant server, and an authentication server, all being interconnected over a computer network;
(b) the identity verification agent including means for positively identifying the customer when the customer personally presents the credit card to the identity verification agent, and means for transmitting a record of the positive identification along with information from the credit card to the authentication server;
(c) the authentication web server configured to generate a unique code associated with the positive identification, store the record of the positive identification along with the code, and transmit the code to the identity verification agent for presentation to the customer;
(d) the customer computer including input means for receiving information from the credit card along with the code generated by the authentication server and output means for transmitting the code and credit card information to the authentication server;
(e) the authentication server further including means for comparing the credit card information and code received from the customer computer with that previously stored on the authentication server as a result of the positive identification by the identity verification agent, means for generating a unique digital certificate, and means for transmitting the certificate to customer computer; and
(f) the merchant server including means for determining whether a valid digital certificate issued from the authentication server is present on the customer computer.

28. The system of claim 27 wherein the identity verification agent comprises an automated teller machine interconnected with an automated teller machine network.

29. The system of claim 28 wherein the means for positively identifying the customer comprises an automated teller machine input device whereby the customer may input a personal identification number, and means for determining whether the personal identification number entered by the customer is a correct personal identification number previously associated with the credit card.

30. The system of claim 27 wherein the identity verification agent comprises a human attendant having a credit card point-of-sale terminal.

31. The system of claim 30 wherein the means for positively identifying the customer comprises the attendant viewing a picture identification of the customer.

32. The system of claim 30 wherein the means for positively identifying the customer comprises the attendant comparing a customer signature made in the attendant's presence with a customer signature on the credit card.

33. The system of claim 30 wherein the means for positively identifying the customer comprises a personal identification number entered by the customer into the point-of-sale terminal, the point of sale terminal verifying whether the number entered by the customer is correct via a point-of-sale terminal network.

34. The system of claim 27 further including means for the identity verification agent to record biometric data from the customer when the identity verification agent positively identifies the customer.

35. The system of claim 34 further including means associated with the customer's computer for recording the customer's biometric data and transmitting the biometric data to the merchant web server.

36. The system of claim 35 further including means for comparing the biometric data recorded by the identity verification agent with that transmitted by the customer to the merchant.

37. The system of claim 36 wherein the biometric data comprises a digitized finger print.

38. The system of claim 36 wherein the biometric data comprises a retinal scan.

39. The system of claim 27 wherein the merchant web server means for determining whether a valid digital certificate is present on the customer's computer comprises:
means for sending the certificate and the customer's credit card information from the merchant to the authentication server, whereby the authentication server determines whether the certificate and the credit card information submitted by the customer are valid.

40. The system of claim 27 whereby the authentication server is operated by an agent of the merchant, and whereby authorization for the transaction is obtained by a card issuer responsible for issuing the customer's credit card or a card issuer authorizing agent.

41. A process for increasing security in credit card transactions occurring remotely between a credit cardholder's computer and a merchant server over a computer network, the process comprising:
(a) reading a credit card containing information at a designated identifier;
(b) performing an identification transaction wherein the identifier determines whether the cardholder is authorized to use the credit card and, if so, an authentication server issues a code temporarily binding the identity of an individual possessing both the code and information printed on the credit card to that of the credit cardholder who presented the credit card to the identifier;
(c) creating a record of the identification transaction including the credit card information, the code, and the identity of the credit cardholder on an authentication server connected to a computer network;
(d) submitting the credit card information and the code from the cardholder's computer to the authentication server over a computer network;
(e) comparing the credit card information and code submitted from the cardholder's computer to the credit card information and code stored in the record of the identification transaction on the authentication server;
(f) transmitting a digital certificate from the authentication server to the cardholder's computer when the card information and the code submitted from the cardholder's computer match the card information and code stored in the record of the identification transaction on the authentication server;
whereby the presence of a digital certificate on the cardholder's computer indicates to the merchant's server in subsequent transactions with the cardholder's computer that the cardholder is the owner of the card.
